(19) United States
(12) Patent Application Publication
(10) Pub. No.: US 2021/0203047 A1
(43) Pub. Date: Jul. 1, 2021

(54) CYLINDRICAL BATTERIES

(71) Applicant: SANYO Electric Co., Ltd., Daito-shi, Osaka (JP)

(72) Inventors: Shin Haraguchi, Hyogo (JP); Kyosuke Miyata, Osaka (JP)

(73) Assignee: SANYO Electric Co., Ltd., Daito-shi, Osaka (JP)

(21) Appl. No.: 16/756,272

(22) PCT Filed: Oct. 15, 2018
(86) PCT No.: PCT/JP2018/038239

§ 371 Date: Apr. 15, 2020

(30) Foreign Application Priority Data
Oct. 23, 2017 (JP) 2017-204480

(51) Int. Cl. H01M 50/578; H01M 50/107; H01M 50/167; H01M 50/317

(52) U.S. Cl. CPC H01M 50/578; H01M 50/107; H01M 2200/20; H01M 50/317; H01M 50/167

(57) ABSTRACT

A cylindrical battery with a sealing unit that includes a valve member which has a circular shape in plan view, an insulating plate which is disposed in contact with a surface of the valve member directed to the inside of the battery and which has an opening in a central region, and a metal plate which is opposed to the valve member with the insulating plate interposed therebetween and which is connected to a central portion of the valve member through the opening of the insulating plate. The valve member is configured so that the central portion and an outer peripheral portion are thicker, the central portion and the outer peripheral portion are connected to each other through an intermediate portion that is thinner having a flat surface extending along a radial direction, and the intermediate portion is in contact with the insulating plate from an inner to outer perimeter.

### TECHNICAL FIELD

The present invention relates to a cylindrical battery which includes a sealing unit having a current interrupting mechanism.

### BACKGROUND ART

PTL 1 discloses a cylindrical battery which has a sealing unit including a current interrupting mechanism composed of a valve member, an insulating member and a metal plate. In this sealing unit, the metal plate is fixed to the valve member via the insulating member. The valve member has a projecting portion in its central region. This projecting portion is connected to a central portion of the metal plate. A sloping region is disposed around the projecting portion of the valve member. In the sloping region, the thickness decreases continuously along the radial direction from the inner periphery to the outer periphery.

In the event that an inner pressure increase occurs in a battery which includes a sealing unit with the current interrupting mechanism described above, the inner pressure acts on the valve member through a vent hole disposed in the metal plate and pushes the valve member toward the battery's surrounding so as to pull the portion of the valve member that is connected to the central portion of the metal plate. When the inner pressure of the battery reaches a predetermined value, the metal plate is ruptured at its portion connected to the valve member or at a notched thinner portion of the metal plate to interrupt the current path between the valve member and the metal plate. If the inner pressure of the battery is thereafter elevated further, the valve member is ruptured at its thinner portion which defines the outermost periphery of the sloping region of the valve member, thereby releasing the gas from the inside of the battery.

### CITATION LIST

### Patent Literature

PTL 1: WO 2016/157749

### SUMMARY OF INVENTION

### Technical Problem

In the cylindrical battery described in PTL 1, the valve member, by virtue of its having a sloping region, is deformed stably as the pressure inside the battery is increased. Thus, the current interrupting mechanism can be activated with a reduced variation in actuation pressure. It is, however, desirable that a current interrupting mechanism be activated at a more stable actuation pressure.

In a cylindrical battery which has a sealing unit including a current interrupting mechanism composed of a valve member, an insulating plate and a metal plate, an object of the present invention is to stabilize the actuation pressure at which the current interrupting mechanism is activated.

### Solution to Problem

A cylindrical battery according to the present invention includes an electrode assembly including a positive electrode plate and a negative electrode plate wound together via a separator, an electrolytic solution, a bottomed cylindrical exterior case accommodating the electrode assembly and the electrolytic solution, and a sealing unit fixed by crimping of an open end portion of the exterior case via a gasket, wherein the sealing unit includes a valve member which has a circular shape in plan view, an insulating plate which is disposed in contact with a surface of the valve member directed to the inside of the battery and which has an opening in a central region, and a metal plate which is opposed to the valve member with the insulating plate interposed therebetween and which is connected to a central portion of the valve member through the opening of the insulating plate, and the valve member is configured so that the central portion and an outer peripheral portion thereof are thicker portions, the central portion and the outer peripheral portion are connected to each other through an intermediate portion that is a thinner portion having a flat surface extending along a radial direction, and the intermediate portion is in contact with the insulating plate all over from an inner perimeter to an outer perimeter.

### Advantageous Effects of Invention

In the cylindrical battery according to the present invention which has a sealing unit including a current interrupting mechanism composed of a valve member, an insulating plate and a metal plate, the pressure at which the current interrupting mechanism is actuated can be stabilized.

### BRIEF DESCRIPTION OF DRAWINGS

FIG. 1 is a sectional view of a cylindrical battery according to an embodiment of the present invention.

FIG. 2(a) is a sectional view of a sealing unit of the cylindrical battery according to the embodiment, and FIG. 2(b) is a sectional view of a sealing unit representing a comparative example.

FIG. 3 is a sectional view of a cylindrical battery according to another embodiment in which a sealing unit includes a terminal cap.

FIG. 4 is a set of views illustrating modified examples of valve members.

### DESCRIPTION OF EMBODIMENTS

Hereinbelow, embodiments of the present invention will be described in detail with reference to the accompanying drawings. In the description, specific shapes, materials, numerical values, directions, etc. are only illustrations for helping understanding of the present invention, and may be changed appropriately in accordance with use applications, purposes, specifications and the like. While the following description may illustrate a plurality of embodiments and other examples such as modified examples, the use of an appropriate combination of characteristics of such embodiments and examples is within the original intentions.

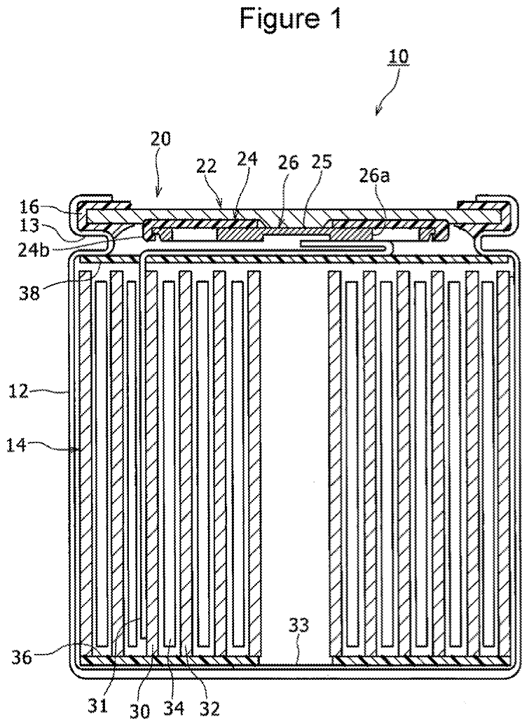

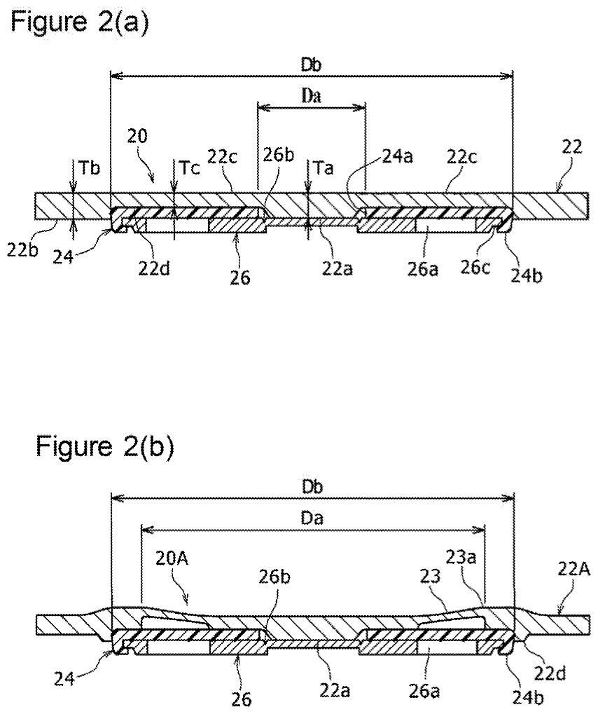

FIG. 1 is a sectional view of a cylindrical battery 10 according to an embodiment of the present invention. FIG. 2 includes a sectional view of a sealing unit 20. The cylindrical battery 10 is, for example, a nonaqueous electrolyte secondary battery.

As illustrated in FIG. 1, the cylindrical battery 10 includes a bottomed cylindrical exterior case 12 and, accommodated in the exterior case, an electrode assembly 14 and an electrolytic solution which is not shown. The open end portion of the exterior case 12 is crimped to fix the sealing unit 20 via a gasket 16, thereby sealing the inside of the battery.

The sealing unit 20 is composed of a valve member 22, an insulating plate 24 and a metal plate 26. The sealing unit 20 constitutes a current interrupting mechanism. The valve member 22 has a circular shape in plan view. The insulating plate 24 is disposed in contact with the surface of the valve member 22 directed to the inside of the battery.

The insulating plate 24 has an annular shape in plan view, and has an opening 24a in a central region. The inner diameter of the opening 24a is preferably not less than 3 mm. This size of inner diameter allows central portions of the valve member 22 and the metal plate 26 to be stably and reliably connected to each other.

The metal plate 26 has a circular outline in plan view, and is opposed to the valve member 22 with the insulating plate 24 interposed therebetween. The central portions of the valve member 22 and the metal plate 26 are connected to each other through the opening 24a of the insulating plate 24. In the present embodiment, the valve member 22 is exposed outside of the battery and serves as an external terminal (more specifically, a positive electrode terminal).

The current interrupting mechanism is actuated in the following manner. A vent hole 26a is disposed in the metal plate 26, and the insulating plate 24 has a vent hole (not shown). If the pressure inside the battery is increased, the valve member 22 receives the pressure through the vent hole 26a in the metal plate 26 and the vent hole in the insulating plate 24. As a result, the valve member 22 acts to pull the portion of the metal plate 26 that is connected thereto farther toward the battery's surrounding as the pressure inside the battery is raised. If the pressure inside the battery reaches a predetermined value, the metal plate 26 is ruptured at its portion connected to the valve member 22 or at a groove 26b disposed in the metal plate 26 to interrupt the current path between the valve member 22 and the metal plate 26. If the inner pressure of the battery is thereafter elevated further after the actuation of the current interrupting mechanism, the valve member 22 is ruptured at its intermediate portion 22c described later which is a thinner portion, thereby releasing the gas from the inside of the battery.

The valve member 22 may be fabricated by pressing a plate material made of aluminum or an aluminum alloy. Aluminum and aluminum alloys are highly flexible and are thus preferable as the materials of the valve members 22.

The valve member 22 has a circular shape in plan view, and includes a central portion 22a and an outer peripheral portion 22b which are thicker portions with thicknesses Ta and Tb, respectively. Meanwhile, the intermediate portion 22c which connects the central portion 22a and the outer peripheral portion 22b to each other is a thinner portion with a thickness Tc. The thickness Tc of the intermediate portion 22c is smaller than the thickness Ta of the central portion 22a and is smaller than the thickness Tb of the outer peripheral portion 22b. In the valve member 22, the thickness Ta of the central portion 22a and the thickness Tb of the outer peripheral portion 22b may be the same as or different from each other.

The thickness Tc of the intermediate portion 22c is preferably uniform from the inner perimeter to the outer perimeter. Adopting a uniform thickness is advantageous in that the valve member 22 may be fabricated easily. However, the intermediate portion 22c is not limited to having a uniform thickness, and may have a thickness Tc which continuously decreases or increases from the inner perimeter to the outer perimeter.

The central portion 22a of the valve member 22 has a larger thickness. Thus, the central portion 22a forms a flattened cylindrical column whose surface is protrudent toward the inside of the battery. As a result of the central portion 22a being protrudent, the valve member 22 is easily connected to the metal plate 26, and can offer a space in which the insulating plate 24 is interposed between the valve member 22 and the metal plate 26.

The surface of the valve member 22 on the exterior side of the battery is preferably flat. As a result of this surface being flat, a current collector may be advantageously connected more reliably by, for example, ultrasonic joining to the surface of the valve member 22 serving as an external terminal. The shape of this surface is not limited thereto and may be such that, for example, the surface of the valve member 22 on the exterior side of the battery is swollen to reach the top at the central portion 22a.

As mentioned above, the surface of the valve member 22 on the exterior side of the battery may be flat. In this case, the intermediate portion 22c which is a thinner portion with a thickness Tc defines an annular recessed portion 22d on the side of the valve member 22 which is directed to the inside of the battery. The insulating plate 24 is fitted into the recessed portion 22d and is fixed therein. The metal plate 26 is fitted within the inner periphery of the insulating plate 24 and is fixed therein. Thus, the metal plate 26 is fixed to the valve member 22 via the insulating plate 24.

The surface of the thin intermediate portion 22c which is directed to the inside of the battery (that is, the bottom surface of the recessed portion 22d defined by the intermediate portion 22c) is a flat surface extending along the radial direction of the valve member 22. As a result, the intermediate portion 22c of the valve member 22 is in contact with the insulating plate 24 fitted in the recessed portion 22d, all over from the inner perimeter to the outer perimeter.

The insulating plate 24 may be any material which can ensure insulation and does not adversely affect the battery characteristics. Preferred materials of the insulating plates 24 are polymer resins, with examples including polypropylene (PP) resins and polybutylene terephthalate (PBT) resins.

The insulating plate 24 has a skirt portion 24b which is disposed at its outer periphery so as to extend toward the inside of the battery. The metal plate 26 is fitted within the inner periphery of the skirt portion 24b and is fixed therein. A tip portion of the skirt portion 24b may be bent toward the central portion 22a of the valve member 22. In this manner, the metal plate 26 and the skirt portion 24b may be assembled with an engagement between a flange portion 26c disposed on the outer periphery of the metal plate and the tip of the skirt portion, and thereby the metal plate 26 can be reliably prevented from misalignment with respect to the insulating plate 24.

The metal plate 26 is a circle in plan view which has a smaller diameter than the insulating plate 24, and includes a central thinner portion. Similarly to the valve member 22, the metal plate 26 is preferably formed of aluminum or an aluminum alloy. In this case, the central portions of the valve member 22 and the metal plate 26 may be connected to each other easily. These portions are preferably connected together by laser welding. The vent hole 26a is disposed through an outer peripheral portion of the metal plate 26. The flange portion 26c disposed on the outer peripheral edge of the metal plate 26 is held by the skirt portion 24b of the insulating plate 24.

The sealing unit 20 is assembled as described below. First, a valve member 22, an insulating plate 24 and a metal plate 26 for constituting a sealing unit 20 are provided. Next, the metal plate 26 is fitted into the inside of a skirt portion 24b of the insulating plate 24, and subsequently the insulating plate 24 is fitted into a recessed portion 22d of the valve member 22. The above two procedures for fitting the members together may be performed in the reversed order.

The valve member 22 and the metal plate 26 are preferably connected together after the completion of the above fitting process for the reason that the connection can be accomplished while the valve member 22 and the metal plate 26 are stationary relative to each other and thus the variation in bond strength is reduced.

In the sealing unit 20 of the cylindrical battery 10 according to the present embodiment, as mentioned hereinabove, the insulating plate 24 to which the metal plate 26 is fixed is in contact with the intermediate portion 22c of the valve member 22 all over from the inner perimeter to the outer perimeter. Thus, in the event where the pressure inside the battery is increased to generate a force which pushes the metal plate 26 and the insulating plate 24 toward the battery's surrounding, the metal plate 26 and the insulating plate 24 are prevented from deformation by virtue of their being supported in contact by the intermediate portion 22c of the valve member 22. As a result, the pressure at which the current interrupting mechanism is actuated can be stabilized.

Next, the electrode assembly 14 will be described. As illustrated in FIG. 1, the electrode assembly 14 used in the present embodiment is one fabricated by winding a positive electrode plate 30 and a negative electrode plate 32 via a separator 34.

For example, the positive electrode plate 30 may be fabricated as follows. First, a positive electrode active material and a binder are kneaded to uniformity in a dispersion medium to give a positive electrode mixture slurry. The binder is preferably polyvinylidene fluoride, and the dispersion medium is preferably N-methylpyrrolidone. A conductive agent such as graphite or carbon black is preferably added to the positive electrode mixture slurry. The positive electrode mixture slurry is applied onto a positive electrode current collector, and the wet film is dried to form a positive electrode mixture layer. During this process, part of the positive electrode current collector is left exposed from the positive electrode mixture layer. The positive electrode mixture layer is then compressed to a predetermined thickness with a roller, and the compressed electrode plate is cut to a predetermined size. Lastly, a positive electrode lead 31 is connected to the exposed portion of the positive electrode current collector. A positive electrode plate 30 is thus obtained.

The positive electrode active material may be a lithium transition metal composite oxide capable of storing and releasing lithium ions. Examples of the lithium transition metal composite oxides include those of the general formulae LiMO₂ (M is at least one of Co, Ni and Mn), LiMn₂O₄ and LiFePO₄. These materials may be used singly, or two or more may be used as a mixture. The material may contain at least one selected from the group consisting of Al, Ti, Mg and Zr, in addition to or in place of the transition metal element.

For example, the negative electrode plate 32 may be fabricated as follows. First, a negative electrode active material and a binder are kneaded to uniformity in a dispersion medium to give a negative electrode mixture slurry. The binder is preferably styrene butadiene (SBR) copolymer, and the dispersion medium is preferably water. A thickening agent such as carboxymethylcellulose is preferably added to the negative electrode mixture slurry. The negative electrode mixture slurry is applied onto a negative electrode current collector, and the wet film is dried to form a negative electrode mixture layer. During this process, part of the negative electrode current collector is left exposed from the negative electrode mixture layer. The negative electrode mixture layer is then compressed to a predetermined thickness with a roller, and the compressed electrode plate is cut to a predetermined size. Lastly, a negative electrode lead 33 is connected to the exposed portion of the negative electrode current collector. A negative electrode plate 32 is thus obtained.

The negative electrode active material may be a carbon material or a metal material which each can store and release lithium ions. Examples of the carbon materials include graphites such as natural graphite and artificial graphite. Examples of the metal materials include silicon, tin and oxides of these metals. The carbon materials and the metal materials may be each used singly, or two or more may be used as a mixture.

The separator 34 may be a microporous film based on a polyolefin such as polyethylene (PE) or polypropylene (PP). A single microporous film, or a stack of two or more such films may be used. In the case where the separator is a stack including two or more layers, it is preferable that a layer based on polyethylene (PE) having a low melting point be an intermediate layer, and polypropylene (PP) having excellent oxidation resistance be a surface layer. Further, inorganic particles such as aluminum oxide (Al₂O₃), titanium oxide (TiO₂) or silicon oxide (SiO₂) may be added to the separator 34. Such inorganic particles may be suspended within the separator or may be applied together with a binder onto the separator surface.

The nonaqueous electrolytic solution may be a solution of a lithium salt as an electrolyte salt in a nonaqueous solvent.

Some nonaqueous solvents that can be used are cyclic carbonate esters, chain carbonate esters, cyclic carboxylate esters and chain carboxylate esters. Preferably, two or more of these solvents are used as a mixture. Examples of the cyclic carbonate esters include ethylene carbonate (EC), propylene carbonate (PC) and butylene carbonate (BC). The cyclic carbonate esters may be substituted with fluorine in place of part of the hydrogen atoms, with examples including fluoroethylene carbonate (FEC). Examples of the chain carbonate esters include dimethyl carbonate (DMC), ethyl methyl carbonate (EMC), diethyl carbonate (DEC) and methyl propyl carbonate (MPC). Examples of the cyclic carboxylate esters include γ-butyrolactone (γ-BL) and γ-valerolactone (γ-VL). Examples of the chain carboxylate esters include methyl pivalate, ethyl pivalate, methyl isobutyrate and methyl propionate.

Examples of the lithium salts include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀ and Li₂B₁₂Cl₁₂. Of these, LiPF₆ is particularly preferable. The concentration in the nonaqueous electrolytic solution is preferably 0.5 to 2.0 mol/L. LiPF₆ may be mixed with other lithium salt such as LiBF₄.

EXAMPLES of the cylindrical batteries 10 according to the embodiment discussed above will be described in detail hereinbelow.

### Example 1

### (Fabrication of Sealing Unit)

A sealing unit 20 illustrated in FIG. 2(a) was fabricated in the following manner. A valve member 22 and a metal plate 26 with predetermined shapes were fabricated by pressing. A circular aluminum plate with a diameter of 19 mm was used for the valve member 22. The valve member 22 had a thickness Ta at a central portion 22a of 0.8 mm, a thickness Tb at an outer peripheral portion 22b of 0.8 mm, and a thickness Tc at an intermediate portion 22c of 0.1 mm.

A thermoplastic resin plate made of polypropylene was punched into an annular shape. Thereafter, the ring was hot molded into a sectional profile illustrated in FIG. 2(a), and a vent hole was formed therein, thereby fabricating an insulating plate 24. The insulating plate 24 was 15 mm in diameter and 0.4 mm in thickness other than at a skirt portion 24b. The diameter Da of an opening 24a in the insulating plate 24 was 3 mm, and the diameter Db of the outline of the insulating plate was 15 mm.

A circular aluminum plate 13 mm in diameter and 0.6 mm in thickness was used for the metal plate 26. A thinner portion was formed in the center of the metal plate 26, and a vent hole 26a was formed in an outer peripheral portion. A groove 26b which was annular in plan view and V-shaped in cross section was formed around the thinner portion of the metal plate 26. This groove 26b functions as a current interrupting section.

The metal plate 26 fabricated as described above was fitted within the inner periphery of the skirt portion 24b of the insulating plate 24 so that the metal plate 26 would be held by the insulating plate 24. Next, the insulating plate 24 holding the metal plate 26 was fitted into a recessed portion 22d of the valve member 22 and was fixed therein. Thereafter, the central portion 22a of the valve member 22 and the thinner portion of the metal plate 26 were connected to each other by laser welding. A sealing unit 20 was thus fabricated.

In the sealing unit 22 fabricated as described above, as illustrated in FIG. 2(a), the insulating plate 24 was supported in contact by the valve member 22 in the region thereof between the opening 24a which was 3 mm in diameter Da and the outline which was 15 mm in diameter Db, and the metal plate 26 was supported in contact by this supported insulating plate 24.

### (Fabrication of Positive Electrode Plate)

A lithium nickel composite oxide represented by LiNi_{0.91}Co_{0.06}Al_{0.03}O₂ was used as a positive electrode active material. 100 Parts by mass of the positive electrode active material, 1 part by mass of acetylene black (AB) as a conductive agent, and 1 part by mass of polyvinylidene fluoride (PVdF) as a binder were mixed together. The mixture was kneaded in N-methyl-2-pyrrolidone (NMP) as a dispersion medium to give a positive electrode mixture slurry. The positive electrode mixture slurry was applied onto both sides of a 13 μm thick aluminum foil as a positive electrode current collector, and was dried to form positive electrode mixture layers. During this process, part of the positive electrode current collector was left exposed from the positive electrode mixture layer. The positive electrode mixture layers were then compressed with a roller to a packing density of 3.6 g/cm³, and the compressed electrode plate was cut to a predetermined size. Lastly, a positive electrode lead 31 made of aluminum was connected to the exposed portion of the positive electrode current collector. A positive electrode plate 30 was thus fabricated.

### (Fabrication of Negative Electrode Plate)

A mixture of 93 parts by mass of graphite and 7 parts by mass of silicon oxide (SiO) was used as a negative electrode active material. 100 Parts by mass of the negative electrode active material, 1 part by mass of carboxymethylcellulose (CMC) as a thickening agent, and 1 part by mass of styrene butadiene rubber (SBR) as a binder were mixed together. The mixture was kneaded in water as a dispersion medium to give a negative electrode mixture slurry. The negative electrode mixture slurry was applied onto both sides of a 6 μm thick copper foil as a negative electrode current collector, and was dried to form negative electrode mixture layers. During this process, part of the negative electrode current collector was left exposed from the negative electrode mixture layer. The negative electrode mixture layers were then compressed with a roller to a packing density of 1.65 g/cm³, and the compressed electrode plate was cut to a predetermined size. Lastly, a negative electrode lead 33 made of nickel was connected to the exposed portion of the negative electrode current collector. A negative electrode plate 32 was thus fabricated.

### (Fabrication of Electrode Assembly)

The positive electrode plate 30 and the negative electrode plate 32 were wound together via a separator 34 to form an electrode assembly 14. The separator 34 used herein was a microporous polyethylene film which had on one side a heat resistant layer including polyamide and alumina (Al₂O₃) filler.

### (Fabrication of Cylindrical Test Battery)

As illustrated in FIG. 1, a lower insulating plate 36 was placed under the electrode assembly 14, and the electrode assembly 14 was inserted into a bottomed cylindrical exterior case 12. The negative electrode lead 33 was connected to the bottom of the exterior case 12 by resistance welding. In the cylindrical test battery, no electrolytic solution was poured into the exterior case 12.

Next, an upper insulating plate 38 was placed on top of the electrode assembly 14, and a portion of the exterior case 12 near the open end was plastically deformed to form a U-shaped hollow 13 in the circumferential direction. The upper end portion of the positive electrode lead 31 was connected to the metal plate 26, and the sealing unit 20 was fitted onto the hollow 13 of the exterior case 12 via a gasket 16 and was fixed there by crimping. A cylindrical test battery 21 mm in outer diameter and 70 mm in height was thus fabricated.

### Comparative Example 1

A sealing unit 20A illustrated in FIG. 2(b) was fabricated for use in a cylindrical test battery of COMPARATIVE EXAMPLE 1. In the sealing unit 20A, a valve member 22A had a sloping region 23 between a central portion 22a and an outer peripheral portion. In the sloping region 23, the thickness continuously decreased along the radial direction from the inner periphery to the outer periphery, and the thickness of an outermost peripheral portion 23a was 0.2 mm. The outermost peripheral portion 23a of the sloping region 23 serves as an origin of fracture when the valve member 22 functions as a safety valve upon an increase in pressure inside the battery.

In the valve member 22A, the presence of the sloping region 23 gives rise to a space under the sloping region 23 which isolates the sloping region 23 of the valve member 22A from the insulating plate 24. In the sealing unit 20A of COMPARATIVE EXAMPLE 1, further, a slight gap was formed between the valve member 22A and the insulating plate 24 so that the valve member 22A was out of contact with the insulating plate 24 also over the region enclosed by the central portion 22a and the sloping region 23. Thus, the sealing unit 20A of COMPARATIVE EXAMPLE 1 was configured so that, as illustrated in FIG. 2(b), the insulating plate 24 was supported in contact by the valve member 22 in the region thereof between the outermost peripheral portion 23a of the sloping region 23 which was located at a diameter Da of 10 mm and the outline of the insulating plate 24 which was 15 mm in diameter Db, and the metal plate 26 was supported in contact by this supported insulating plate 24.

Besides the valve member 22A in the sealing unit 20A fabricated above, the insulating plate 24 and the metal plate 26 were the same as those used in EXAMPLE 1. A cylindrical test battery was fabricated in the same manner as in EXAMPLE 1 using this sealing unit 20A.

### (Measurement of Actuation Pressure of Current Interrupting Mechanism)

Thirty cylindrical test batteries were fabricated using the sealing units 20 of EXAMPLE 1 and another thirty were fabricated using the sealing units 20A of COMPARATIVE EXAMPLE 1. A through hole with a diameter of 3 mm was formed through the bottom of the exterior case 12 of each cylindrical test battery, and a copper tube was inserted thereinto. The gap between the though hole and the copper tube was tightly sealed with a sealant. Air was injected through the copper tube into the cylindrical test battery at a pressurization rate of 0.3 MPa/sec to increase the pressure inside the battery. The actuation pressure which caused the actuation of the current interrupting mechanism was measured. This measurement was performed on thirty sealing units 20 and on thirty sealing units 20A. The respective standard deviations of the actuation pressures of the sealing units 20 and of the sealing units 20A were calculated. The results are described in Table 1 below.

TABLE 1

| | | COMPARATIVE |
|---|---|---|
| | EXAMPLE 1 | EXAMPLE 1 |
| Range of contact | From 3 mm location | From 10 mm location |
| | to 15 mm location | to 15 mm location on |
| | on diameter | diameter |
| Standard deviation | 0.03 | 0.05 |
| of actuation | | |
| pressure (MPa) | | |

As shown in Table 1, EXAMPLE 1 in which the metal plate 26 was supported by the valve member 22 via the insulating plate 24 over the region of the metal plate 26 extending from the outermost periphery to the vicinity of the central thinner portion achieved a relatively small variation in pressure causing the actuation of the current interrupting mechanism. COMPARATIVE EXAMPLE 1 in which the metal plate 26 was supported by the valve member 22A via the insulating plate 24 only over the outer peripheral portion thereof resulted in a relatively large variation in pressure causing the actuation of the current interrupting mechanism. The reasons behind these results are probably because, by virtue of the metal plate 26 being supported in contact by the valve member 22 over the increased region extending to the vicinity of the thinner portion of the metal plate, the metal plate 26 and the insulating plate 24 are prevented from being deformed toward the battery's surrounding by the increase in pressure inside the battery and consequently the thinner portion of the metal plate 26 is allowed to rupture in a stable manner.

The configurations of the cylindrical batteries according to the present invention are not limited to the embodiment described hereinabove and modified examples thereof. Various modifications and improvements are possible without departing from the spirit of the present invention.

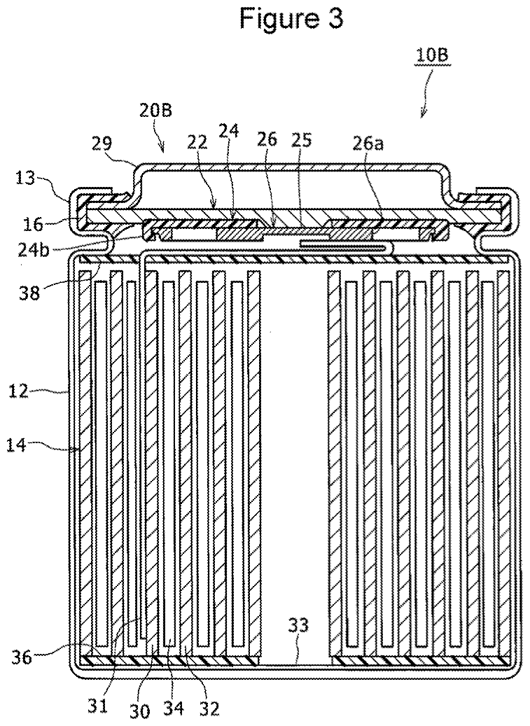

For example, while the above embodiment has illustrated the valve member 22 as being exposed on the outside of the cylindrical battery 10 to function as an external terminal, the configuration is not limited thereto. As illustrated in FIG. 3, a cylindrical battery 10B may have a sealing unit 20B which is of a type that a terminal cap 29 is disposed on a valve member 22 and the terminal cap 29 is used as an external terminal. In this case, the terminal cap 29 is protrudent in a substantially columnar shape at a central portion thereof, and has a vent hole which is not shown. Further, an outer peripheral portion of the terminal cap 29 is fixed by crimping of an upper end portion of an exterior case 12 via a gasket 16. The cylindrical battery 10B which has the sealing unit 20B including the terminal cap 29 can benefit from the similar advantageous effects described in the embodiment hereinabove.

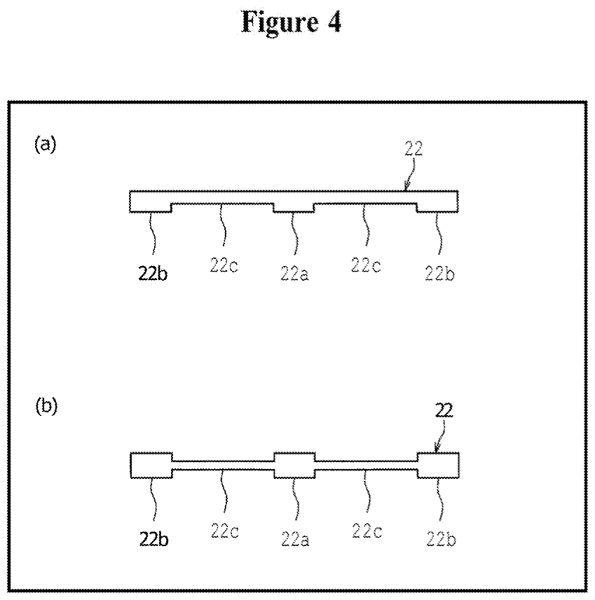

Further, while the above embodiment has illustrated the central portion 22a and the outer peripheral portion 22b of the valve member 22 as being protrudent on one side as illustrated in FIG. 4(a), the configuration is not limited thereto and may be such that, as illustrated in FIG. 4(b), the central portion 22a and the outer peripheral portion 22b protrude on both sides of the valve member 22.

### REFERENCE SIGNS LIST

10, 10B CYLINDRICAL BATTERY, 12 EXTERIOR CASE, 13 HOLLOW, 14 ELECTRODE ASSEMBLY, 16 GASKET, 20, 20A, 20B SEALING UNIT, 22 VALVE MEMBER, 22a CENTRAL PORTION, 22b OUTER PERIPHERAL PORTION, 22c INTERMEDIATE PORTION, 22d RECESSED PORTION, 23 SLOPING REGION, 23a OUTERMOST PERIPHERAL PORTION, 24 INSULATING PLATE, 24a OPENING, 24b SKIRT PORTION, 26 METAL PLATE, 26b GROOVE, 26c FLANGE PORTION, 29 TERMINAL CAP, 30 POSITIVE ELECTRODE PLATE, 31 POSITIVE ELECTRODE LEAD, 32 NEGATIVE ELECTRODE PLATE, 33 NEGATIVE ELECTRODE LEAD, 34 SEPARATOR, 36 LOWER INSULATING PLATE, 38 UPPER INSULATING PLATE

1. A cylindrical battery comprising an electrode assembly including a positive electrode plate and a negative electrode plate wound together via a separator, an electrolytic solution, a bottomed cylindrical exterior case accommodating the electrode assembly and the electrolytic solution, and a sealing unit fixed by crimping of an open end portion of the exterior case via a gasket, wherein
the sealing unit comprises a valve member which has a circular shape in plan view, an insulating plate which is disposed in contact with a surface of the valve member directed to the inside of the battery and which has an opening in a central region, and a metal plate which is opposed to the valve member with the insulating plate interposed therebetween and which is connected to a central portion of the valve member through the opening of the insulating plate, and
the valve member is configured so that the central portion and an outer peripheral portion thereof are thicker portions, the central portion and the outer peripheral portion are connected to each other through an intermediate portion that is a thinner portion having a flat surface extending along a radial direction, and the intermediate portion is in contact with the insulating plate all over from an inner perimeter to an outer perimeter.

2. The cylindrical battery according to claim 1, wherein the thickness of the intermediate portion is uniform from the inner perimeter to the outer perimeter.

3. The cylindrical battery according to claim 1, wherein the inner diameter of the opening in the insulating plate is not less than 3 mm.

4. The cylindrical battery according to claim 1, wherein a surface of the valve member on the exterior side of the battery is flat.

5. The cylindrical battery according to claim 1, wherein the sealing fruit further comprises, a terminal cap disposed on the valve member.
